(19) United States
(12) Patent Application Publication
(10) Pub. No.: US 2019/0070683 A1
(43) Pub. Date: Mar. 7, 2019

(54) TOOL AND METHOD FOR PROCESSING A CHANNEL WITHIN AN ELECTRICALLY CONDUCTIVE COMPONENT

(71) Applicant: ROLLS-ROYCE PLC, London (GB)

(72) Inventor: James MCCLENNAN, Derby (GB)

(73) Assignee: ROLLS-ROYCE PLC, London (GB)

(21) Appl. No.: 16/105,405

(22) Filed: Aug. 20, 2018

(30) Foreign Application Priority Data
Sep. 5, 2017 (GB) 1714211.8

(51) Int. Cl. B23H 1/02; B23H 7/22

(52) U.S. Cl. CPC B23H 1/02; B23H 7/22

(57) ABSTRACT

A tool is provided for use in processing a pre-formed channel within an electrically conductive component in order to reduce and/or inspect local protrusions left on the surface of the channel by the initial channel forming process, the tool comprising:
a probe including a stem that is elongate in an axial direction and is configured to be inserted into the channel, and at least one electrode formed on the stem that is electrically isolated from the stem;
a DC electric power supply, configured to establish an electric potential between the at least one electrode and the electrically conductive component in which the channel is formed; and
an electrolyte solution supply configured to provide a flow of electrolyte solution into the channel.

The present disclosure concerns a tool and a method for use in processing a pre-formed channel within an electrically conductive component.

In particular, the present disclosure relates to the processing of high aspect ratio channels, namely those that are relatively narrow compared to their length. Such channels may, for example, be formed in components used within a gas turbine engine. Such channels may be used to form film cooling holes in a turbine blade or nozzle guide vane, for example.

Such channels may be formed by electrical discharge machining. Such a process leaves a recast metal layer and a heat-affected zone. The recast layer and heat-affected zone may contain dendritic metal crystals as a result of the combination of the heat from the electrical discharge and an environment flooded with the coolant. This may also result in the walls of the channels having nodules of melt material formed on the channel walls. These abnormalities on the channel walls, which may be significant in size relative to the cross-section of the channels, may affect coolant gas flow in use of the components.

Furthermore, components having such channels may be further processed by processes such as electroplating and other coating processes to create a thermal barrier coating. During such processes, abnormalities formed on the surface of the channel may be preferentially coated leading to further localised restrictions of the coolant gas flow.

Restrictions formed in channels for coolant gas flow within a component in a gas turbine engine may result in variation of the mass flow of coolant gas through the channels. This in turn may result in variation of the gas turbine specific fuel consumption which, in turn, may increase fuel consumption and reduce performance characteristics of the gas turbine engine relative to that which may otherwise be obtained.

According to an aspect there is provided a tool for use in processing a pre-formed channel within an electrically conductive component in order to reduce and/or inspect local protrusions left on the surface of the channel by the initial channel forming process, the tool comprising:
a probe including a stem that is elongate in an axial direction and is configured to he inserted into the channel, and at least one electrode formed on the stem that is electrically isolated from the stem;
a DC electric power supply, configured to establish an electric potential between the at least one electrode and the electrically conductive component in which the channel s formed; and
an electrolyte solution supply configured to provide a flow of electrolyte solution into the channel,

In an aspect, a plurality of electrodes may be formed on the stem of the probe. A plurality of electrodes may be spaced apart along the length of the stem in the axial direction.

In an aspect, at least one electrode surrounds the stem at its position along the length of the stem in the axial direction.

In an aspect, at least one electrode is provided on one side of the stem relative to the axial direction of the stern and electrically isolated from material on the surface of the stem on the opposite side of the stem.

In an aspect, each of the electrodes is electrically isolated from the other electrodes. The DC electric power supply may be configured to independently control the power supplied to each of the electrodes.

In an aspect, a plurality of electrical conductors may be provided within the stem, each connected to the DC electric power supply and to a respective one of the electrodes.

In an aspect, an electrical conductor may be provided within the stem and configured to have an adjustable position within the stem along the axial direction. The electrical conductor may be connected to the DC electric power supply and, at different positions of the electrical conductor along the axial direction, the electrical conductor may be electrically connected to a respective different electrode.

In an aspect, an electrical conductor may be provided within the stem and configured to rotate within the stem about an axis of rotation that is parallel to the axial direction of the stem. The electrical conductor may be connected to the DC electric power supply and, at different rotational positions of the conductor about its axis of rotation, the electrical conductor may be electrically connected to a respective different electrode.

In an aspect, the DC electric power supply may be configured to be operable in a protrusion removal mode in which an electric current is provided via at least one electrode such that, in the presence of the electrolyte solution provided by the electrolyte solution supply, material on the surface of the channel adjacent to the electrode is electrochemically removed. The DC electric power supply may be configured to provide one or more pulses of electric current via the at least one electrode, in which the electric current gradually increases within each pulse.

In an aspect, the electrolyte solution supply is configured to provide a flow of electrolyte solution along the channel in a flow direction; and the DC electric power supply is configured to successively provide electric current to a plurality of electrodes that are arranged along the stem of the probe such that each electrode that receives electric current is further along the stern in the flow direction than the next electrode to be provided with the electric current.

In an aspect, the DC electric power supply is configured to be operable in an inspection mode in which a constant voltage is provided to at least one electrode. The tool may further comprise a monitor for measuring the electric current flowing between the electrode and the electrically conductive component. The tool may further comprise a controller, configured to determine data relating to the size of a protrusion on the surface of the channel adjacent the electrode from the measurement of the electric current flow at the constant voltage.

In an aspect the tool may further comprise an actuator configured to control the position of the probe within the channel in at least one of a linear direction parallel to the axial direction of the probe and a rotational direction about an axis that is parallel to the axial direction of the probe.

In an aspect, the tool comprises a plurality of probes, each having at least one electrode configured to be electrically connected to the DC electric power supply. The cross-section and/or length of each probe may be different from other probes.

According to an aspect, there is provided a method of processing a pre-formed channel within an electrically conductive component in order to reduce and/or inspect local protrusions left on the surface of the channel by the initial channel forming process, the method comprising:
inserting a probe into the channel, the probe including a stem that is elongate in an axial direction and at least one electrode formed on the stem that is electrically isolated from the stem;
establishing a DC electric potential between the at least one electrode and the electrically conductive component in which the channel is formed; and
providing a flow of electrolyte solution into the channel.

In an aspect, the method may include a protrusion removal step, in which the DC electric potential creates an electric current through the electrolyte solution between the at least one electrode and the electrically conductive component such that material on the surface of the channel adjacent to the electrode is electrochemically removed.

The DC electric potential in the protrusion removal step may be provided in one or more pulses of electric current via the at least one electrode, in which the electric current gradually increases within each pulse.

In an aspect, the electrolyte solution may be provided such that it flows along the channel in a flow direction. The DC electric potential may be successively provided to a plurality of electrodes that are arranged along the stem of the probe such that each electrode that receives electric current is further along the stern in the flow direction than the next electrode to be provided with the electric current.

In an aspect, the method may include an inspection step, in which a constant voltage is provided to at least one electrode. The inspection step may further include measuring the electric current flowing between the electrode and the electrically conductive component. The inspection step may further comprise determining data relating to the size of a protrusion on the surface of the channel adjacent the electrode from the measurement of the electric current flow at the constant voltage.

In an aspect, the method may further include selecting a probe to be inserted into the channel from a plurality of probes wherein the cross-section and/or length of each probe is different from other probes.

The skilled person will appreciate that, except where mutually exclusive, a feature described in relation to any one of the above aspects may be applied mutatis mutandis to any other aspect. Furthermore, except when mutually exclusive, any feature described herein may be applied to any aspect and/or combined with any other feature described herein.

Embodiments will now be described by way of example only, with reference to the figures in which:

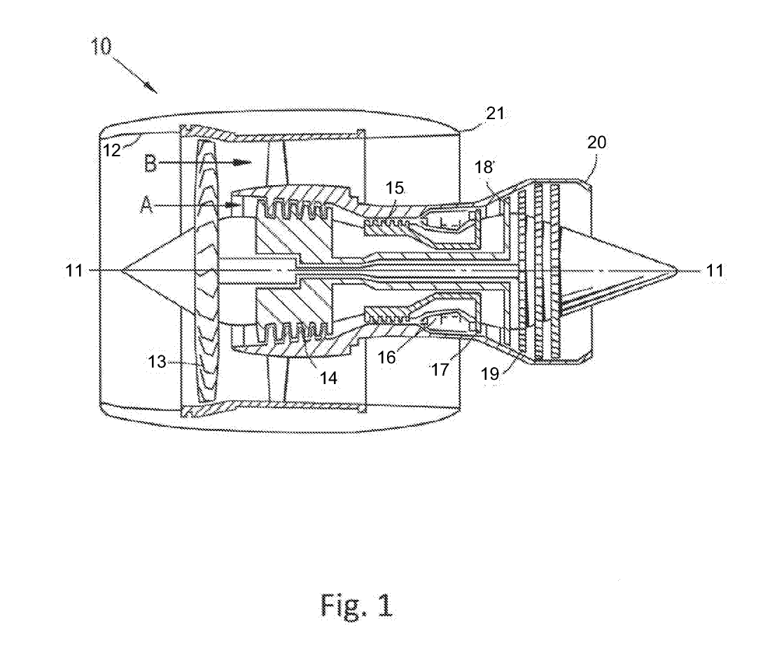

FIG. 1 is a sectional side view of a gas turbine engine;

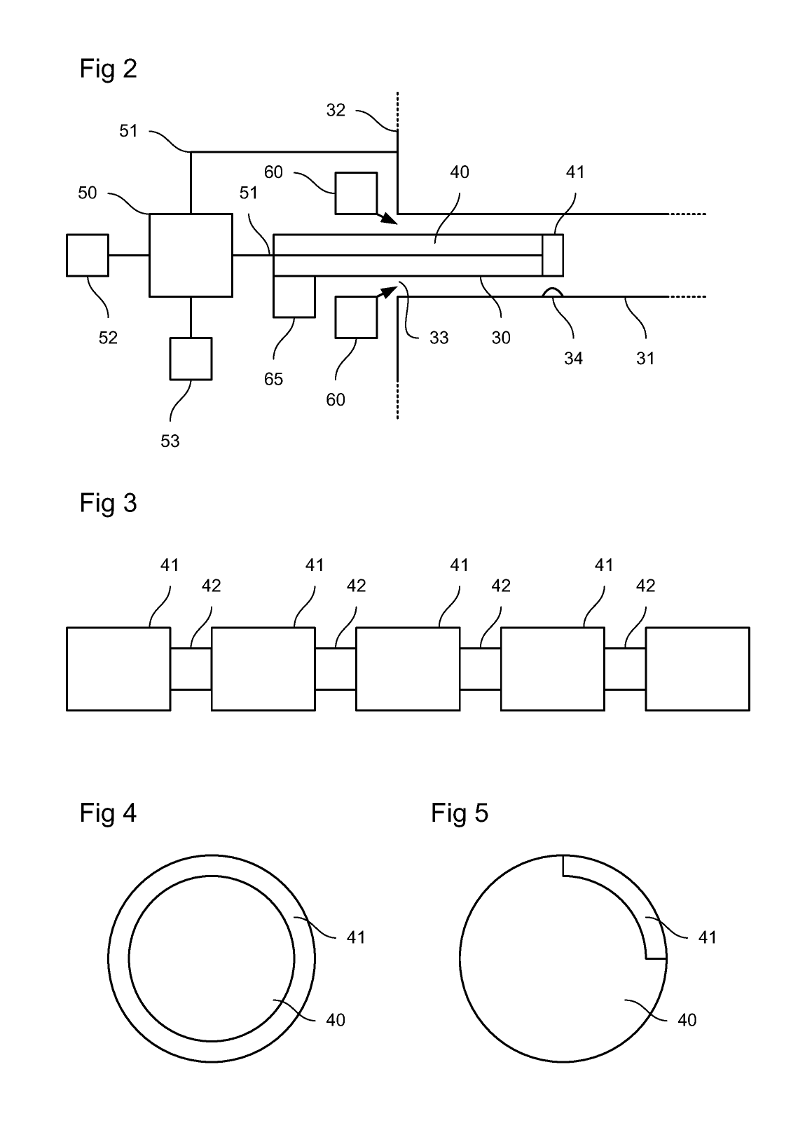

FIG. 2 is a schematic depiction of the arrangement of a tool according to the present disclosure;

FIG. 3 schematically depicts a probe that may be used as part of the tool according to the present disclosure;

FIGS. 4 and 5 schematically depict, in axial cross-section, optional arrangements of an electrode provided on a probe for use in the tool according to the present disclosure; and

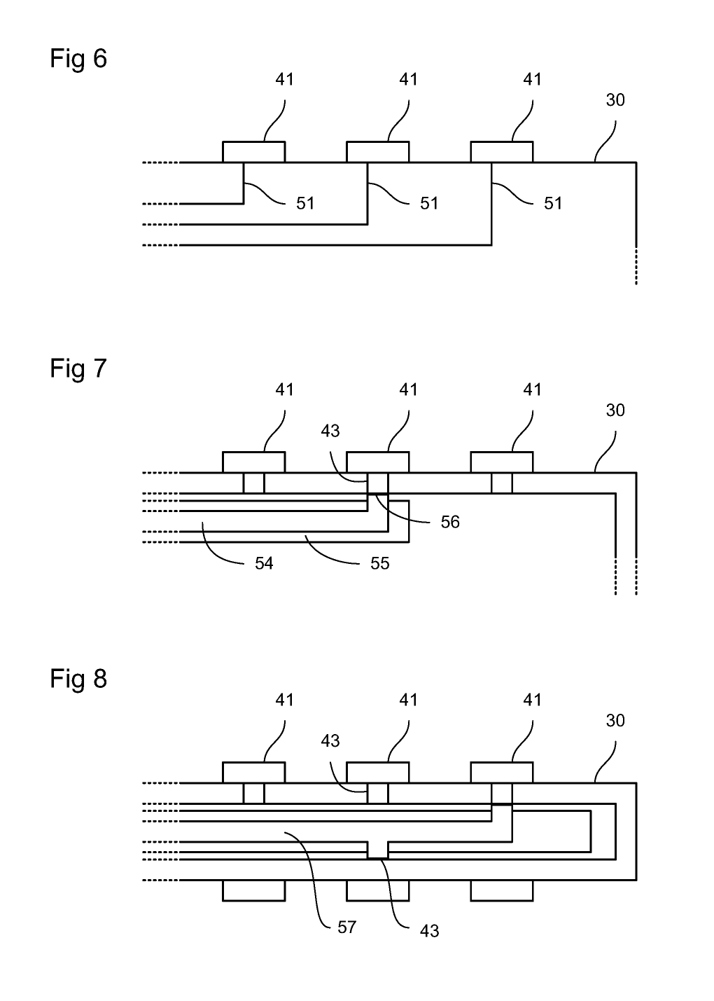

FIGS. 6 to 8 schematically depict, in longitudinal cross-section, optional arrangements for controlling the electric power provided to the electrodes of a probe for use within the tool of the present disclosure.

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The tool of the present disclosure may be used in processing channels formed within components of a gas turbine engine such as that discussed above, which may include, but is not limited to, aerofoil components such as, for example, rotor blades, stator blades, or vanes. However, the tool may also be used for processing channels formed in other components.

FIG. 2 schematically depicts a tool according to the present disclosure. As shown, it includes an elongate probe 30 that is configured to be able to be inserted into a channel 31 that has previously been formed within an electrically conductive component 32. The probe 30 is elongated in an axial direction and has a cross-section slightly smaller than that of the channel 31. Consequently, for even a high aspect ratio channel, the distal end of the probe 30 may be inserted deep within the channel 31. This may enable processing of the surface of the channel not only near the opening 33 of the channel 31 at a surface of the component 32 but also processing of the surface of the channel 31 deeper within the component 32.

The probe 30 includes a stem 40 on which is provided at least one electrode 41. The electrode 41 is formed on the stem 40 in such a way that it is electrically isolated from the remainder of the surface of the stem 40. This may be achieved by provision of an electrical insulator between the electrode 41 and the stem 40 and/or by the stem 40 being primarily formed from a material that is an electrical insulator.

The tool further includes a DC electric power supply 50, configured to controllably establish an electric potential between the at least one electrode 41 and the electrically conductive component 32. In particular, electrical conductors 51 may be provided between the DC electric power supply and the electrically conductive component 32 and the electrode 41.

The tool further comprises an electrolyte solution supply 60 arranged to provide a flow of electrolyte solution into the channel 31. As schematically depicted in FIG. 2, the electrolyte solution supply 60 may be arranged to provide a flow of electrolyte solution into the channel 31 through the opening 33 into which the probe 30 is inserted. Alternatively or additionally, the electrolyte solution supply may he connected to another opening that connects with the channel 31. In such an arrangement, the electrolyte solution may flow through the channel 31 and exit the component 32 through the opening 33 into which the probe 30 is inserted.

In some arrangements, the electrolyte solution may enter the channel 31 and exit the channel 31 by the same opening. In other arrangements, the electrolyte solution may enter the channel 31 through a first opening and exit through a second opening, which may facilitate the provision of a reliable flow of electrolyte solution passing the at least one electrode 41.

The tool may further include an actuator 65 used to control the position of the probe 30. In particular, the actuator 65 may be used to insert the probe 30 into the opening 33 into the channel 31. Depending on the provision of the at least one electrode 41, discussed further below, the actuator 65 may be configured to move the probe 30 between an uninserted position and an inserted position within the channel 31. Alternatively or additionally, the actuator 65 may be configured to adjust the position of the probe 30 relative to the channel 31, for example in order to position at least one electrode 41 adjacent to a protrusion 34 formed on the surface of the channel 31.

Depending on the configuration of the electrodes 41, discussed further below, and/or the requirements for the positional control of the probe, the actuator 65 may be configured to control the position of the probe 30 in a linear direction parallel to the axial direction of the probe 30 and/or rotationally about an axis that is parallel to the axial direction of the probe.

The tool may be configured to be able to operate in one or both of two modes of operation that may be used in processing the pre-formed channel 31 in order to reduce the local protrusions 34 left on the surface of the channel 31 by the channel forming process. The first mode of operation may be used in order to reduce the local protrusions 34, namely to improve the surface smoothness of the channel 31. The second mode of operation may be used in order to determine the location and/or size of protrusions 34 within the channel 31.

Information obtained regarding the location and/or size of protrusions 34 may be used in order to control a subsequent step in which such protrusions 34 are reduced. Alternatively or additionally, such information may be used to confirm whether the surface of the channel 31 meets a required quality assessment, namely whether the size and/or number of such protrusions is below a required threshold. This assessment may be made before a step of processing to reduce protrusions 34, in order to determine if the step is necessary, and/or after an initial step of processing to reduce protrusions 34, in order to determine whether the process has been successful or whether further work is required.

The provision of a tool that may both operate to reduce local protrusions 34 within a channel 31 and may be used to inspect a channel 31 in order to determine the extent of protrusions remaining on the surface of the channel 31 may be beneficial. In particular, such a tool may be able to target the processing of sections of the channel at which one or more protrusion 34 is located. Furthermore, the use of the same tool for both inspection and machining may reduce the total time taken to inspect and machine the channel 31.

In the first mode of operation, namely a protrusion removal mode, the DC electric power supply may be configured to provide an electric current between the at least one electrode 41 and the electrically conductive component 32 by way of the electrolytes solution which is provided within the channel 31. The DC electric power supply is configured such that the at least one electrode 41 provided on the probe 30 functions as a cathode and the surface of the channel 31 of the electrically conductive component 32 functions as an anode. As electric current flows in this process, material from the wall of the channel 31 adjacent the electrode 41 is electrochemically removed.

The flow of the electrolyte solution removes the electrolytic by-products that are formed in the process. This may reduce or prevent the plating of metal on the electrode 41.

When an electrode 41 is placed adjacent a protrusion 34, the protrusion 34 will be closer to the electrode 41 than the surrounding surface of the channel 31 that is also adjacent to the electrode 41. Consequently, the protrusion 34 will be eroded at a faster rate than the remainder of the surface of the channel 31. In some uses of the tool, therefore, the tool may be used in the protrusion removal mode in such a way that each section of the surface of the channel 31 is processed regardless of whether or not a protrusion 34 is known to be present. Such an arrangement may reduce the number and size of protrusions 34 existing on the surface of the channel 31 without significantly eroding any other localised regions of the surface of the channel 31. Accordingly, the smoothness of the surface of the channel 31 may be generally improved without having first inspected the channel.

Alternatively or additionally, where the location of one or more protrusions 34 is known, the tool may be operated to specifically locate an electrode 41 adjacent to the protrusion 34 in order to target the material erosion and reduce the size of the protrusion 34.

In general, it is should be appreciated that the size of the electric current provided by the DC electric power supply 50 may determine the rate of removal of material. Accordingly, the size of electric current used may be selected in order to balance a desire to shorten processing time with the need to provide adequate control of the process and/or to avoid short-circuiting that may occur if the electric current is too high. If particular protrusions 34 are targeted, and their size is known, the size of electric current and/or duration of processing may be selected to reduce the protrusion 34 to an acceptable level. The electric current may be provided in ramped pulses. This may reduce the likelihood of short circuiting and/or may enable a more even spread of electrical charge.

In general, the electrodes 41 may be formed from any suitably electrically conductive material. They may, for example, be formed from a copper-chrome or copper-tungsten alloy. Similarly, any appropriate electrolyte solution may be used, such as one or more of sodium nitrate, sodium chloride or a combination of these with other salts.

It should be appreciated that, for high aspect ratio channels, the electrolyte solution supply may need to provide the electrolyte solution at a relatively high pressure in order to provide sufficient flow rates. Consequently, this flow itself may be sufficient to dislodge some debris that remains within the channel 31 after the initial channel forming process. It may therefore be desirable to start the flow of electrolyte solution before providing the electric current to electrochemically remove protrusions and/or before inserting the probe 30 within the channel 31.

During electrochemical processing, gas products may be generated. It is desirable for these to be removed from the location of electrochemical processing. It may therefore be desirable to orient the component 32 during such processing such that the channel is arranged vertically in the region in which electrochemical processing is to occur. In such an arrangement, under the effect of gravity, allows gaseous by-products to effervesce upwards away from the electrode 41 and towards an opening. In an arrangement in which the electrolytes solution is configured to flow along the channel 31, this may be arranged also to flow upwards, namely such that the gaseous products naturally flow in the same direction as the flow of electrolyte solution within the channel 31.

In the second mode of operation, namely an inspection mode, the tool may be used, as discussed above, to detect the location and/or size of a protrusion 34 on the surface of the channel 31. In this mode of operation, the DC electric power supply may be configured to provide a constant voltage between at least one electrode 41 and the electrically conductive component 32. This voltage may be significantly lower than that used for the protrusion removal operation mode. Accordingly, in the inspection mode, no significant material erosion may be expected.

A tool configured to operate in the inspection mode may also include a monitor 52 that monitors the resultant electric current flowing between the electrode 41 and the electrically conductive component 32 as a result of the constant voltage. The current registered is inversely proportional to the resistant encountered. The resistance in turn is proportional to the amount of electrolyte solution between the surface of the channel 31 and the electrode 41. Accordingly, an increased electric current relative to a base level suggests a reduction in the gap, namely the presence of a protrusion adjacent to the electrode 41.

It should be appreciated that, even if the area of a protrusion 34 on the surface of the channel 31 is relatively small compared to the area of the surface of the channel 31 adjacent an electrode 41, the change in electrical current will be dominated by the presence of a protrusion 34. This is because, in effect, the electron stream paths in the electrolyte may be thought of as a series of parallel resistances in a circuit. The location of a protrusion 34, resulting in a significantly reduced resistance locally, will dominate the overall resistance between the electrode 41 and the electrically conductive component 32.

A controller 53 may be configured to determine the size and/or location of a protrusion based on the measurement of electrical current flowing via the one or more electrodes.

The tool may be configured to identify the position of a protrusion 34 within the channel 31 based on information regarding at least one of the position of the electrode 41 at which an elevated current is recorded relative to the stem 40 of the probe 30, the position of the stem 40 relative to the component 32, particularly if the position of the stem 40 may be adjusted relative to the electrically conductive component 32 by an actuator 65, and information identifying at which of the electrodes 41 the elevated current is recorded in the case of a tool using a probe 30 having a plurality of electrodes 41. The size of the electric current, for example its increase relative to a base level for a given system configuration, may be used to determine data regarding the size of a protrusion 34 adjacent to the electrode 41.

During processing of a pre-formed channel, a tool that is configured to operate in both an inspection mode and in a protrusion removal mode may, as discussed above, be configured to inspect the channel first and subsequently target protrusions to be removed in the removal process. Alternatively or additionally, the tool may successively switch between the protrusion removal mode and the inspection mode in order to monitor progress in removing protrusions. The tool may also be configured to perform a final inspection of the channel 31 after completion of processing in order to verify that the surface smoothness of the channel 31 is within desired tolerances.

As depicted in FIG. 2, the probe 30 may have a single electrode 41, for example provided at the distal end of the stem 40. Alternatively, the probe 30 may include a plurality of electrodes 41. The plurality of electrodes may be electrically isolated from each other. In such an arrangement, the DC electric power supply may be configured to independently control the power supply to each of the electrodes. This may enable removal of protrusions at multiple locations within a channel 31 and/or identification of the presence of protrusions at one or more locations simultaneously.

As schematically shown in FIG. 3, in an arrangement the probe 30 may include a plurality of electrodes 41 spaced apart along the length of the stem 40 in the axial direction. The adjacent electrodes 41 may be separated from each other by sections of insulating material. Probes 30 may generally be made as long as desirable by provision of a sufficient number of alternating sections of electrode 41 and insulating spacer 42.

In a tool using a probe 30 such as that depicted in FIG. 3, all sections of the surface of the channel 31 may be rendered adjacent a section of electrode 41 by movement of the inserted probe 30 in the axial direction by a distance equivalent to the length of the insulating spacer sections 42. Therefore, in use of the probe 30 to process a channel, the probe may be fully inserted and subsequently reciprocally moved by a distance corresponding to the length of the insulating spacer sections 42.

As schematically depicted in the axial cross-section shown in FIG. 4, in an arrangement one or more electrodes 41 may be configured to surround the stem 40 of the probe 30 at the position of the electrode 41 along the length of the stem 40 in the axial direction. Such an electrode may be able to electrochemically remove material from protrusions around a band of the surface of the channel 31 without moving the probe 30.

In an arrangement, as schematically depicted in the axial cross-section shown in FIG. 5, at least one electrode 41 may be arranged on one side only of the stem 40. This may permit an electrode 41 to be positioned adjacent a protrusion 34 without affecting the surface of the channel 31 on the opposite side of the channel. Such an arrangement may enable more accurate determination of the position of a protrusion in operation of the inspection mode discussed above and/or more targeted electrochemical machining of a protrusion in operation of the protrusion removal mode discussed above. A tool configured to use such a probe may be configured such that its actuator for controlling the position of the probe 30 is able to control the position of the probe 30 in a rotational direction about an axis of rotational that is parallel to the elongate axis of the probe 30.

In a tool using a probe 30 having a plurality of electrodes 41, the DC electric power supply 50 may provide the same electric power to all of the electrodes 41. This may make a construction of the probe 30 simpler.

In an alternative arrangement, the tool may be configured such that the DC electric power supply 50 may independently control the electric power provided to each of a plurality of electrodes 41. Such an arrangement may enable control of electrochemical removal of material from protrusions adjacent selected electrodes 41 and/or identification of the electrode 41 a protrusion 34 is adjacent, as discussed above. In any case, a controller 53 may be provided to control the operation of the DC electric power supply 50.

As schematically shown in FIG. 6, which is a longitudinal cross-section of a part of a probe 30, in order to independently control the electric current provided to a plurality of electrodes 41, each of the electrodes 41 may be connected to the DC electric power supply 50 by a respective electrical conductor 51 arranged within the stem 40 of the probe 30.

Alternatively or additionally, a plurality of electrodes 41 may be connected to the DC electric power supply 50 by an arrangement such as that schematically depicted in FIG. 7, which is a partial longitudinal cross-section of a probe 30. In such an arrangement, an electrical conductor 54 is provided within the probe 30 and arranged such that it may be moved in a direction parallel to the axial direction of the probe 30.

The axially moveable conductor 54 within the probe 30 may be encased in electrically insulating material 55 except for a contact point 56. Movement of the conductor 54 in the axial direction may be arranged such that the electrical conductor 54 may be moved between different positions. At each of the different positions, the contact point 56 of the electrical conductor 54 is in electrical contact with an electrical contact 43 associated with a different respective electrode 41. In such a way, at each position, the DC electric power supply is connected to a single electrode 41 by way of the axially moveable electrical conductor 54. It should be appreciated that the electrical contacts 43 associated with each of the electrodes 41 may be a separate connection point, as depicted in FIG. 7, or may be a part of the electrode 41 itself.

Alternatively or additionally, a plurality of electrodes 41 may be selectively connected to the DC electric power supply 50 by an arrangement such as that schematically depicted in FIG. 8, which is a partial longitudinal cross-section of a probe 30. This arrangement is similar to that discussed above in relation to FIG. 7 in that it includes the arrangement of a moveable electrical conductor provided within the probe 30. In this arrangement, the moveable electrical conductor 57 may be rotated about an axis of rotation that is parallel to the elongate axis of the probe 30 in order to control which one of a plurality of contact points 58 provided on the rotatable electrical conductor 57 are in contact with a respective electrical contact point 43 connected to a respective electrode 41.

Variations of the above described arrangements for connecting individual electrodes 41 to the DC electric power supply 50 and/or alternative arrangements may be used.

As depicted in FIGS. 4 and 5, the probes 30 used in the present invention may have a circular cross-section. However, in the event of the probes being used to process channels having a cross-section that is not circular, it should be appreciated that the cross-section of the probes may likewise be changed. In general, the cross-section of the probe 30 may correspond to the cross-section of the channel 31 to be processed. Likewise, the desirable size of the cross-section of the probe 30 may be determined by the size of the cross-section of the channel 31 to be processed.

In an arrangement, the tool may include a plurality of different probes 30, differing from each other by at least one of the cross-sectional size, cross-sectional shape and length. The tool may be configured to use an appropriate probe 30 for a given channel 31 to be processed.

In an arrangement, the actuator 65 be connected to the plurality of probes 30 and configured to, on command, insert the selected probe 30 into a channel 31. In an alternative arrangement, the actuator 65 may be configured such that one or more probes 30 may be detachably connected to the actuator 65. Accordingly, the actuator may be configured to connect to a selected probe 30 before it is inserted in a channel 31. The construction of the detachable connection of the probe 30 to the actuator 65 may be configured also to provide detachable connection of the probe 30 to the DC electric power supply 50.

It will be understood that the invention is not limited to the embodiments above-described and various modifications and improvements can be made without departing from the concept described herein. Except where mutually exclusive, any of the features may be employed separately or in combination with any other features and the disclosure extends to and includes all combinations and sub-combinations of one or more features described herein.

1. A tool for use in processing a pre-formed channel within an electrically conductive component in order to reduce and/or inspect local protrusions left on the surface of the channel by the initial channel forming process, the tool comprising;
a probe including a stem that is elongate in an axial direction and is configured to be inserted into the channel, and at least one electrode formed on the stem that is electrically isolated from the stem;
a DC electric power supply, configured to establish an electric potential between the at least one electrode and the electrically conductive component in which the channel is formed; and
an electrolyte solution supply configured to provide a flow of electrolyte solution into the channel.

2. A tool according to claim 1, wherein a plurality of electrodes are formed on the stem of the probe.

3. A tool according to claim 2, wherein a plurality of electrodes are spaced apart along the length of the stem in the axial direction.

4. A tool according to claim 2, wherein at least one electrode surrounds the stem at its position along the length of the stem in the axial direction.

5. A tool according to claim 2, wherein at least one electrode is provided on one side of the stern relative to the axial direction of the stem and electrically isolated from material on the surface of the stem on the opposite side of the stem.

6. A tool according to claim 2, wherein each of the electrodes is electrically isolated from the other electrodes; and
the DC electric power supply is configured to independently control power supplied to each of the electrodes.

7. A tool according to claim 2, further comprising a plurality of electrical conductors provided within the stem, each connected to the DC electric power supply and to a respective one of the electrodes.

8. A tool for use in processing a pre-formed channel within an electrically conductive component in order to reduce and/or inspect local protrusions left on the surface of the channel by the initial channel forming process, the tool comprising:
a probe including a stem that is elongate in an axial direction and is configured to be inserted into the channel, and at least one electrode formed on the stem that is electrically isolated from the stem;
a DC electric power supply, configured to establish an electric potential between the at least one electrode and the electrically conductive component in which the channel is formed; and
an electrolyte solution supply configured to provide a flow of electrolyte solution into the channel;
wherein a plurality of electrodes are formed on the stem of the probe;
the tool further comprising an electrical conductor provided within the stern and configured to have an adjustable position within the stein along the axial direction;
wherein the electrical conductor is connected to the DC electric power supply and, at different positions of the electrical conductor along the axial direction, the electrical conductor is electrically connected to a respective different electrode.

9. A tool for use in processing a pre-formed channel within an electrically conductive component in order to reduce and/or inspect local protrusions left on the surface of the channel by the initial channel forming process, the tool comprising:
a probe including a stem that is elongate in an axial direction and is configured to be inserted into the channel, and at least one electrode formed on the stem that is electrically isolated from the stem;
a DC electric power supply, configured to establish an electric potential between the at least one electrode and the electrically conductive component in which the channel is formed; and
an electrolyte solution supply configured to provide a flow of electrolyte solution into the channel;
wherein a plurality of electrodes are formed on the stem of the probe;
further comprising an electrical conductor provided within the stern and configured to rotate within the stem about an axis of rotation that is parallel to the axial direction of the stem;
wherein the electrical conductor is connected to the DC electric power supply and, at different rotational positions of the conductor about its axis of rotation, the electrical conductor is electrically connected to a respective different electrode.

10. A tool according to claim 1, wherein the DC electric power supply is configured to be operable in a protrusion removal mode in which an electric current is provided via at least one electrode such that, in the presence of the electrolyte solution provided by the electrolyte solution supply, material on the surface of the channel adjacent to the electrode is electrochemically removed.

11. A tool according to claim 10, wherein the DC electric power supply is configured to provide one or more pulses of electric current via the at least one electrode, in which the electric current gradually increases within each pulse.

12. A tool according to claim 10, wherein the electrolyte solution supply is configured to provide a flow of electrolyte solution along the channel in a flow direction; and
the DC electric power supply is configured to successively provide electric current to a plurality of electrodes that are arranged along the stem of the probe such that each electrode that receives electric current is further along the stem in the flow direction than the next electrode to be provided with the electric current.

13. A tool according to claim 1, wherein the DC electric power supply is configured to he operable in an inspection mode in which a constant voltage is provided to at least one electrode; and
the tool further comprises a monitor for measuring the electric current flowing between the electrode and the electrically conductive component.

14. A tool according to claim 13, further comprising a controller, configured to determine data relating to the size of a protrusion on the surface of the channel adjacent the electrode from the measurement of the electric current flow at the constant voltage.

15. A tool according to claim 1, further comprising an actuator configured to control the position of the probe within the channel in at least one of a linear direction parallel to the axial direction of the probe and a rotational direction about an axis that is parallel to the axial direction of the probe.

16. A tool according to claim 1, wherein the tool comprises a plurality of probes, each having at least one electrode configured to he electrically connected to the DC electric power supply; and wherein the cross-section and/or length of each probe is different from other probes.

17. A method of processing a pre-formed channel within an electrically conductive component in order to reduce and/or inspect local protrusions left on the surface of the channel by the initial channel forming process, the method comprising:
inserting a probe into the channel, the probe including a stem that is elongate in an axial direction and at least one electrode formed on the stem that is electrically isolated from the stem;
establishing a DC electric potential between the at least one electrode and the electrically conductive component in which the channel is formed; and
providing a flow of electrolyte solution into the channel.

18. A method according to claim 17, comprising a protrusion removal step, in which the DC electric potential creates an electric current through the electrolyte solution between the at least one electrode and the electrically conductive component such that material on the surface of the channel adjacent to the electrode is electrochemically removed.

19. A method according to claim 18, wherein the DC electric potential in the protrusion removal step is provided in one or more pulses of electric current via the at least one electrode, in which the electric current gradually increases within each pulse.

20. A method according to claim 18, wherein the electrolyte solution is provided such that it flows along the channel in a flow direction; and
the DC electric potential is successively provided to a plurality of electrodes that are arranged along the stem of the probe such that each electrode that receives electric current is further along the stem in the flow direction than the next electrode to be provided with the electric current.
